(19) United States
(12) Patent Application Publication
(10) Pub. No.: US 2011/0193680 A1
(43) Pub. Date: Aug. 11, 2011

(54) VEHICLE APPLIANCE CONTROL SYSTEM

(75) Inventors: Jason T. Summerford, Novi, MI (US); Riad Ghabra, Dearborn Heights, MI (US)

(73) Assignee: LEAR CORPORATION, Southfield, MI (US)

(21) Appl. No.: 13/009,387

(22) Filed: Jan. 19, 2011

Related U.S. Application Data
(60) Provisional application No. 61/296,294, filed on Jan. 19, 2010.

(51) Int. Cl. G06F 7/04; G08C 19/12

(52) U.S. Cl. 340/5.51; 340/13.24

(57) ABSTRACT

A vehicle system includes a body control module for controlling at least one body control system. The body control module has a microcontroller. A garage door opener module is adapted to be mounted within a vehicle. The garage door module provides an actuating signal for a garage door opener. A keypad is adapted to be mounted on the vehicle and accessible from outside of the vehicle. The keypad provides input to the microcontroller for controlling the garage door opener module.

### CROSS-REFERENCE TO RELATED APPLICATIONS

This application claims the benefit of United States Provisional Application No. 61/296,294, filed Jan. 19, 2010, the disclosure of which is incorporated herein by reference.

### BACKGROUND OF THE INVENTION

This invention relates in general to universal garage door openers and appliance control systems. Home appliances, such as garage door openers, security gates, home alarms, lighting, and the like, may conveniently be operated from a remote control. Typically, the remote control is purchased together with the appliance. The remote control transmits a radio frequency activation signal which is recognized by a receiver associated with the appliance. Aftermarket remote controls are gaining in popularity as such devices can offer functionality different from the original equipment's remote control. Such functionality includes decreased size, multiple appliance interoperability, increased performance, and the like. Aftermarket controllers are also purchased to replace lost or damaged controllers or to simply provide another remote control for accessing the appliance.

An example application for aftermarket remote controls are remote garage door openers integrated into an automotive vehicle. These integrated remote controls provide customer convenience, appliance interoperability, increased safety, and enhanced vehicle value. Present in-vehicle integrated remote controls provide a “universal” or programmable garage door opener which learns characteristics of an activation signal received from an existing transmitter then, when prompted by a user, generates a single activation signal having the same characteristics.

### SUMMARY OF THE INVENTION

This invention relates to appliance control systems and universal garage door openers and, in particular, to vehicle mounted appliance control systems. The system includes a body control module for controlling at least one body control system. The body control module has a microcontroller. A garage door opener module is adapted to be mounted within a vehicle. The garage door module provides an actuating signal for a garage door opener. A keypad is adapted to be mounted on the vehicle and is accessible from outside of the vehicle. The keypad provides input to the microcontroller for controlling the garage door opener module.

Various aspects of this invention will become apparent to those skilled in the art from the following detailed description of the preferred embodiments, when read in light of the accompanying drawings.

### BRIEF DESCRIPTION OF THE DRAWINGS

FIG. 1 is a schematic view of an appliance control system.

FIG. 2 is a schematic view of a vehicle including a plurality of body control systems.

### DETAILED DESCRIPTION OF THE PREFERRED EMBODIMENTS

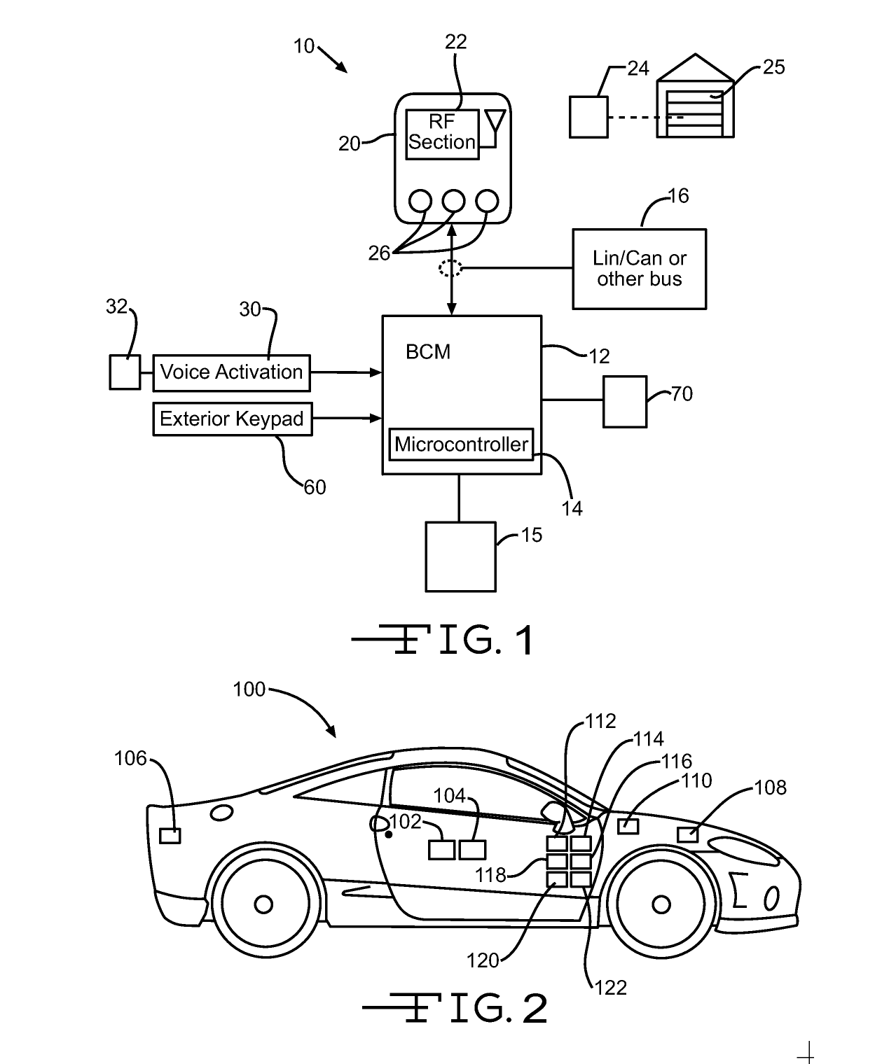

Referring now to the drawings, there is illustrated in FIG. 1 an appliance control system, indicated generally at 10. The components of the system 10 are preferably installed within or on a vehicle. The system 10 may be similar in structure, function, and/or operation of universal garage door opener systems described in U.S. Pat. No. 7,489,397 and U.S. Patent Application Publication No. 2008/0169899, which are hereby incorporated by reference herein. Various features of the systems disclosed in U.S. Pat. No. 7,489,397 and U.S. Patent Application Publication No. 2008/0169899 may be used to construct a universal garage door opener system in accordance with this invention.

The system 10 includes a body control module (BCM), indicated schematically at 12. The body control module 12 includes a microcontroller 14 for activating and controlling various electrical units or body control systems 15. The body control systems 15 can be any system or assembly mounted within or on the vehicle that performs some function during operation of the vehicle. There is illustrated in FIG. 2 a schematic representation of a vehicle 100 including examples of such body controls systems 15. These examples include a door lock mechanism 102, a power window regulator assembly 104, a side door or trunk opener 106, an alarm system 108, a wiper mechanism 110, a heating, ventilating, and air conditioning (HVAC) system 112, a radio/video/gaming system 114, a lighting system 116, a vehicle status and information display system 118, a map and positioning system 120, and a sensor and warning system 122. It should be understood that the examples listed herein should not be interpreted as a complete list such that other vehicle systems not described herein may also be defined as a body control system 15. The body control systems 15 may be connected to the microcontroller 14 via a vehicle network 16, such as a LIN or CAN protocol compliant network.

Referring again to FIG. 1, the system 10 further includes an appliance control module 20. For simplicity, the module 20 will hereafter be referred to as the universal garage door opener (UGDO) module 20 for operating a garage door opener 24. However, it should be understood that the UGDO module 20 is only one example of an appliance control system and the invention should not be limited to such a controlled appliance. Examples of other controlled appliances which may be operated other than the garage door opener include security gates, home alarms, and lighting systems.

The UGDO module may be fixedly mounted on the vehicle or may be in the form of a handheld remote. The remote may be separate from or part of a keyless entry fob (not shown). The UGDO module 20 includes an RF section 22 used to facilitate the wireless communication between a non-vehicle mounted controlled appliance, such as a garage door opener, indicated schematically at 24 The garage door opener 24 opens and closes a movable gate or door 25 mounted on a garage, house or other building structure.

The UGDO module 20 may include user operated switches or buttons 26 for operating or programming the vehicle's universal garage door system. The buttons 26 may be mounted within a vehicle instrument panel, a visor or other interior areas that may be located remotely from the microcontroller 14.

The UGDO module 20 is connected to the microcontroller 14 via the vehicle network 16, or by a hard wired or wireless connection. The microcontroller 14 may control the UGDO module 20 as well as control the various body control systems 15.

The system 10 further includes a cabin voice recognition unit 30 that provides an input to the microcontroller 14 via commands spoken by the user. The unit 30 may include a microphone 32 for converting the spoken commands into an electronic signal which is then analyzed by the voice recognition unit 30 to provide a signal indicative of the command to the microcontroller 14. The microphone 32 may be mounted anywhere within the vehicle cabin for receiving voice commands. Additionally, the microphone 32 may be mounted on the exterior of the vehicle to receive voice commands from someone outside of the vehicle such as when the vehicle is parked. The cabin voice recognition unit 30 may be used by the body control module 12 to control and/or program the various body control systems 15 described above. Additionally, the voice recognition unit 30 may provide a convenient way to operate the garage door opener 24 rather than having to press the buttons 26. The voice recognition unit 30 may operate in a similar manner as described in U.S. Patent Application Publication 2008/0169899 which is incorporated by reference herein.

As stated above, voice commands may be used to operate or program the vehicle's universal garage door opener system 10. However, it should be understood that other inputs such as the buttons 16 or other input devices may be used to operate and/or program the vehicle's universal garage door opener system. For example, the buttons 16 could be replaced (or in addition to) by virtual buttons selectively used with a vehicle touch screen display (or other touch operated device) and input device (not shown). The vehicle's universal garage door opener system could be activated and/or programmed using the touch screen. Selected voice commands could be associated with or linked to one of a plurality of virtual buttons. In another example, during fixed code programming, the switch array from the original transmitter could be represented on the touch screen. Individual dip switches could be set on the touch screen, thereby eliminating the method of pressing the buttons 16. Security gate codes could be inputted numerically in a similar manner.

It should be understood that the precise architecture of the system 10 or any of its components are not limited to that disclosed in FIG. 1 and may be configured in a different manner. For example, the system 10 of FIG. 1 integrates the universal garage door opener logic within the body control module 12 so as to eliminate the need for a dedicated universal garage door opener microcontroller. However, the system 10 could instead include a separate dedicated universal garage door opener microcontroller.

The system 10 may further include a keypad 60 having one or more buttons and/or switches which are depressed by a user operating the keypad. The keypad 60 is preferably mounted on the outside of the vehicle where it may be accessed even though the vehicle is locked. Examples of suitable mounting positions include exterior portions of door panels, door handles, and mirror housings. The keypad 60 may be connected to the microcontroller 44 via a wireless connection, hard wired, or via the network 46 (or another network). The keypad 60 may be used to operate the various body control systems 15 described above. For example, the keypad 60 may be used with a keyless entry system for controlling the door lock mechanism 102, the power window regulator assembly 104, the side door or trunk opener 106, and the alarm system 108. The keypad 60 could be actuated to provide input similar to the buttons 26 or may be configured to operate with a security code input. This provides a convenient way to open the garage door 25 rather than having to first unlock the vehicle to gain access to the vehicle's universal garage door opener system 10. The system 10 may also include wireless key fobs (not shown) for providing input to the body control module 12 or other components of the vehicle's universal garage door opener system 10.

If desired, the universal garage door system 10 in accordance with the invention may have both a voice recognition unit 30 and an exterior keypad 60 that are used to independently operate the garage door opener 24 or any other controlled appliance.

In operation, the system 10 preferably only operates the garage door opener 24 if the system 10 is first authorized by a security input or authorization state. The microcontroller 14 may control the operation of the UGDO module 20 based on security input signals or detection of the authorization state of an auxiliary unit. For example, a security code may need to be first entered on the keypad 60 before the keypad 60 can be operated to activate the garage door opener 24. This helps prevents the unauthorized use of the system 10. In another example, the microcontroller 14 may only operate the UGDO module 20 via the exterior keypad when the vehicle is in a parked position such as by sensing the position of a gear shift selector (not shown). In yet another example, when the cabin voice recognition unit 30 is used to activate the garage door opener 24, a vehicle's ignition switch 70 may first need to be in a predetermined condition. The ignition switch 70 defines the auxiliary unit. For example, a key (not shown) may first need to be inserted into an ignition key lock mechanism (not shown) of the ignition switch 70 prior to the microcontroller 14 of the body control module 12 activating the UGDO module. Alternatively, the authorization states can be the detection of the vehicle's engine running or the key being inserted into the ignition key lock mechanism and in its “on” or “accessory” position but not in its “off” position. The authorization state may also be a function of a predetermined amount of time has passed. For example, the microprocessor 14 may still activate the UGDO module 20 even if the key is not inserted into the key lock mechanism if the operation is performed within a brief period of time after removal of the key.

The principle and mode of operation of this invention have been explained and illustrated in its preferred embodiments. However, it must be understood that this invention may be practiced otherwise than as specifically explained and illustrated without departing from its spirit or scope.

What is claimed is:

1. A system comprising:
a body control module for controlling at least one body control system, said body control module having a microcontroller;
an appliance control module adapted to be mounted within a vehicle, said appliance control module providing an actuating signal for an appliance; and
a keypad adapted to be mounted on the vehicle and accessible from outside of the vehicle, said keypad providing input to said microcontroller for controlling said appliance control module.

2. The system of claim 1, wherein said microcontroller is prevented from activating said appliance control module until a predetermined security code is entered on said keypad.

3. The system of claim 1, wherein said keypad is adapted to be mounted on an exterior portion of a door of the vehicle.

4. The system of claim 1, further including a voice recognition unit providing input to the microcontroller via spoken commands from a user for controlling the appliance control module.

5. The system of claim 4 further including a microphone for converting the spoken commands into an electronic signal provided to said voice recognition unit, wherein said microphone is adapted to be mounted on the vehicle to be able to receive voice commands from someone outside of the vehicle.

6. The system of claim 4, wherein said microcontroller will only operate said appliance control module via input from said keypad when the vehicle is in a parked position.

7. The system of claim 4, wherein said microcontroller activates said appliance control module dependent on an authorization state of an auxiliary unit.

8. The system of claim 7, wherein said auxiliary unit is an ignition switch.

9. The system of claim 1, wherein said keypad includes button operated switches.

10. The system of claim 1, wherein said keypad includes a touch operated device display.

11. The system of claim 1, wherein said keypad is wirelessly connected to said microcontroller.

12. The system of claim 1, wherein said keypad is connected to said microcontroller via a network.

13. The system of claim 1, wherein said body control system includes a door lock mechanism.

14. The system of claim 1, wherein said body control system includes a power window regulator assembly.

15. The system of claim 1, wherein said body control system includes an alarm system.

16. The system of claim 1, wherein said body control system includes a heating, ventilating, and air conditioning (HVAC) system.

17. A system comprising:
a body control module for controlling at least one body control system, said body control module having a microcontroller;
an appliance control module adapted to be mounted within a vehicle, said appliance control module providing an actuating signal for a appliance;
a voice recognition unit providing input to the microcontroller via spoken commands from a user for controlling the appliance control module; and
a keypad adapted to be mounted on an exterior portion of a vehicle and accessible from outside of the vehicle, said keypad providing input to said microcontroller for controlling said appliance control module, wherein said microcontroller will only operate said appliance control module via input from said keypad when the vehicle is in a parked position.
